(19) United States
(12) Patent Application Publication
(10) Pub. No.: US 2026/0312296 A1
(43) Pub. Date: Oct. 8, 2026

(54) CONICAL LENS FOR ANTENNA ARRAY

(71) Applicant: CesiumAstro, Inc., Austin, TX (US)

(72) Inventors: Erik Lier, Phoenixville, PA (US); Thomas Henry Hand, Highlands Ranch, CO (US); Aidan Hamm, Boulder, CO (US); Thomas Magesacher, Austin, TX (US)

(21) Appl. No.: 19/638,274

(22) Filed: Apr. 3, 2026

Related U.S. Application Data
(60) Provisional application No. 63/783,179, filed on Apr. 3, 2025.

(51) Int. Cl. H01Q 21/00; H01Q 3/26; H01Q 15/02

(52) U.S. Cl. CPC H01Q 21/0031; H01Q 3/2676; H01Q 15/02

(57) ABSTRACT

The present disclosure provides an antenna system that includes an active electronically steered array and a truncated conical dielectric lens with a dome positioned over the array to improve wide-angle scan performance. The conical lens has a thickness that increases along an elevation direction and is configured to introduce an elevation-dependent phase delay that enables scan amplification, such that a reduced scan angle of the array produces a larger effective far-field scan angle. In example embodiments, the conical lens may be formed from a high-dielectric-constant material to reduce lens size and mass while achieving a desired time-delay profile. The conical geometry may intrinsically produce a substantially uniform or focused wavefront in elevation, while azimuth non-uniformities introduced by the lens may be compensated using array beamforming.

### CROSS-REFERENCED TO RELATED APPLICATIONS

This application claims priority to U.S. Provisional Patent Application No. 63/783,179, filed Apr. 3, 2025, which is incorporated by reference herein in its entirety.

### TECHNICAL FIELD

This disclosure relates to an antenna array with a truncated conical lens with a dome.

### BACKGROUND

Active electronically steered array (AESA) antenna systems are widely used in RADAR and communication applications because they enable electronic beam steering without mechanical movement. As scan angles increase away from boresight, however, AESA systems typically experience reduced gain, degraded beam quality, and increased scan loss toward wide elevation angles. To address these effects, some conventional solutions have employed dielectric lenses, such as curved or dome-shaped lenses, positioned over the array to redirect energy toward wide scan angles. These approaches often require low-dielectric-constant materials and complex curved geometries, which can result in large size, increased mass, and complicated design and manufacturing processes. In addition, some dome lenses do not naturally produce a uniform or focused wavefront in elevation and frequently require substantial time delay through the lens, further increasing weight and limiting practical implementation, especially in space-constrained or mass-sensitive systems.

### BRIEF DESCRIPTION OF THE DRAWINGS

Various embodiments in accordance with the present disclosure will be described with reference to the drawings, in which:

FIG. 1A illustrates a cross-sectional view of a conical lens having linearly tapered inner and outer surfaces that may produce a substantially uniform or focused wavefront in elevation, according to example embodiments;

FIG. 1B illustrates a cross-sectional view of a truncated conical lens having a reduced height while preserving a linear thickness gradient for elevation beam shaping, according to example embodiments;

FIG. 1C illustrates multiple views of truncated conical lenses having different truncation profiles and symmetry configurations for reducing mass and packaging height, according to example embodiments;

FIG. 1D illustrates a conical lens positioned over an active electronically steered array, wherein a dome section may reduce gain loss at low scan angles and may act as a radome, according to example embodiments;

FIG. 2A illustrates a cross-sectional view of a system in which a conical lens is positioned over an active electronically steered array to enable elevation scan amplification, according to example embodiments;

FIG. 2B illustrates a plan view of a system showing azimuthal beam steering and compensation performed by an active electronically steered array in cooperation with a conical lens, according to example embodiments;

FIG. 2C illustrates a near-field beam cross-section showing phase distributions associated with electromagnetic energy generated by an active electronically steered array and modified by a conical lens, according to example embodiments;

FIG. 2D illustrates a top view of a conical lens and an active electronically steered array showing azimuth phase non-uniformities introduced by the lens and compensated by the array, according to example embodiments;

FIG. 2E illustrates beam transition regions corresponding to different scan angles in which electromagnetic energy may propagate through a conical lens, free space, or both, according to example embodiments;

FIG. 3A illustrates a geometric model defining propagation paths, refraction angles, and phase relationships for electromagnetic energy traversing a conical lens positioned over an active electronically steered array, according to example embodiments;

FIG. 3B illustrates a volume-based design model showing lens height, truncation options, and spacing relationships between a conical lens and an active electronically steered array, according to example embodiments;

FIG. 4A illustrates a deployment system showing stowed and deployed configurations of a conical lens supported above an active electronically steered array, according to example embodiments;

FIG. 4B illustrates a mounting configuration using flexure structures to accommodate thermal expansion differences between a conical lens and an active electronically steered array, according to example embodiments;

FIG. 4C illustrates additional system features including support pillars, absorbers, and a calibration subsystem associated with a conical lens and an active electronically steered array, according to example embodiments;

FIG. 4D illustrates results of a parametric sweep showing performance tradeoffs associated with varying geometric parameters of a conical lens used with an active electronically steered array, according to example embodiments; and

FIG. 5 illustrates a process for directing electromagnetic energy using an active electronically steered array and a conical lens to generate a modified beam for transmission into free space, according to example embodiments.

### DETAILED DESCRIPTION

The present disclosure provides a conical lens for use with an AESA antenna system, where the lens includes inner and outer surfaces having a linear taper that produces a linearly increasing thickness along an elevation direction. This conical geometry may intrinsically generate a substantially uniform or focused wavefront in elevation and enables scan amplification, thereby reducing the maximum scan angle required of the AESA while achieving wider effective far-field coverage. By allowing part of the beam steering to be performed by the lens itself, the disclosed approach reduces scan loss at wide angles and can improve overall directivity. The use of relatively high-dielectric-constant materials allows the required time delay to be achieved with reduced size and weight compared to conventional dome lenses. In addition, any non-uniformities introduced in azimuth may be compensated through AESA beamformer phase or amplitude control. As a result, the present disclosure provides a lens-AESA system that improves wide-angle scan performance while simplifying design, reducing mass, and lowering system complexity relative to conventional solutions.

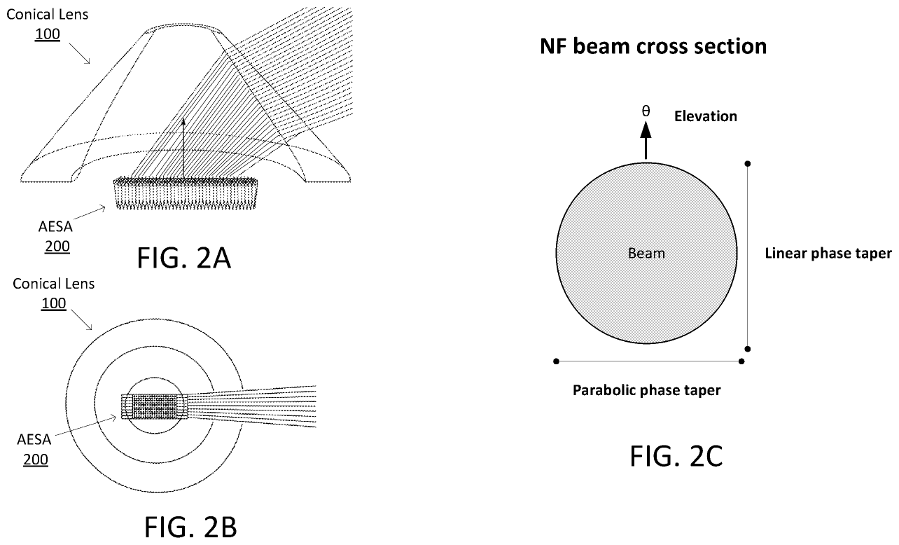

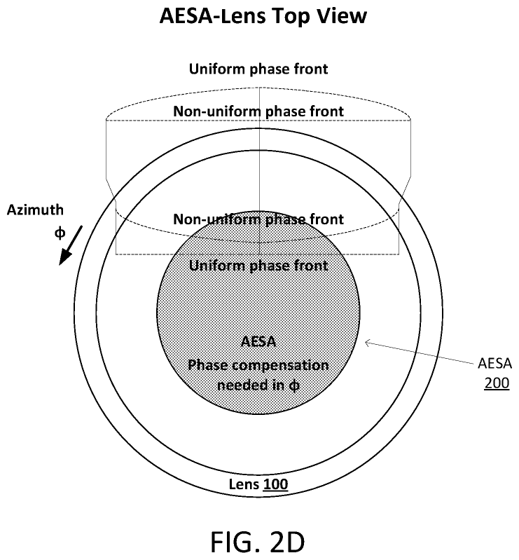

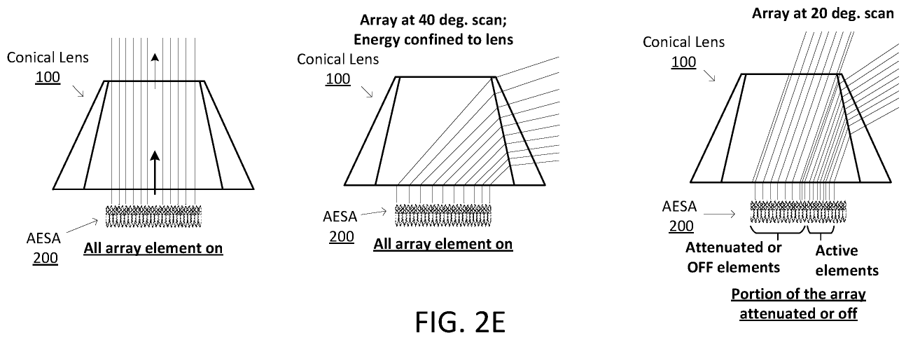

Conventional wide-scan AESA systems have employed dome-shaped dielectric lenses to reduce scan loss at large scan angles, such as scan angles exceeding approximately 60 degrees. As illustrated in FIG. 2A, such dome lenses rely on a curved geometry and increasing lens height to redirect electromagnetic energy toward wide scan directions. By introducing an increasing time delay from a top portion of the dome lens toward a bottom portion of the dome lens, these systems may achieve a form of scan amplification in which a reduced scan angle of the AESA produces a larger effective far-field scan angle. Dome lenses have been implemented using continuous dielectric materials, metamaterials, graded-index (GRIN) structures, or unit-cell-based architectures that employ back-to-back antenna elements and transmission-line delays.

While dome lenses may reduce scan loss at wide angles, such approaches introduce several practical challenges. In particular, achieving the required time delay profile often necessitates large lens height and volume, especially when low-dielectric-constant materials are used, resulting in increased mass and packaging constraints. Additionally, dome lenses typically represent a tradeoff between wide-angle performance and reduced gain near boresight, and they do not inherently produce a uniform or focused wavefront in elevation. As a result, dome-lens-based systems may require complex design optimization, high packaging density, or increased system cost to accommodate the lens geometry and time-delay requirements.

The present disclosure improves upon these dome-lens approaches by employing a conical lens geometry having linearly tapered inner and outer surfaces that produce a linearly increasing thickness along an elevation direction. Unlike curved dome lenses, the conical geometry intrinsically generates a substantially uniform or focused wavefront in elevation while enabling scan amplification using a simpler and more compact structure. By using relatively high-dielectric-constant materials, the conical lens may achieve the desired time-delay profile with reduced physical size and mass compared to dome lenses. In addition, non-uniformities introduced in azimuth by the conical lens may be compensated electronically by the AESA beamformer, allowing the lens and the AESA to cooperatively share beam-steering functions. As a result, the present disclosure provides improved wide-angle scan performance while reducing lens height, mass, and design complexity relative to conventional dome-lens-based systems.

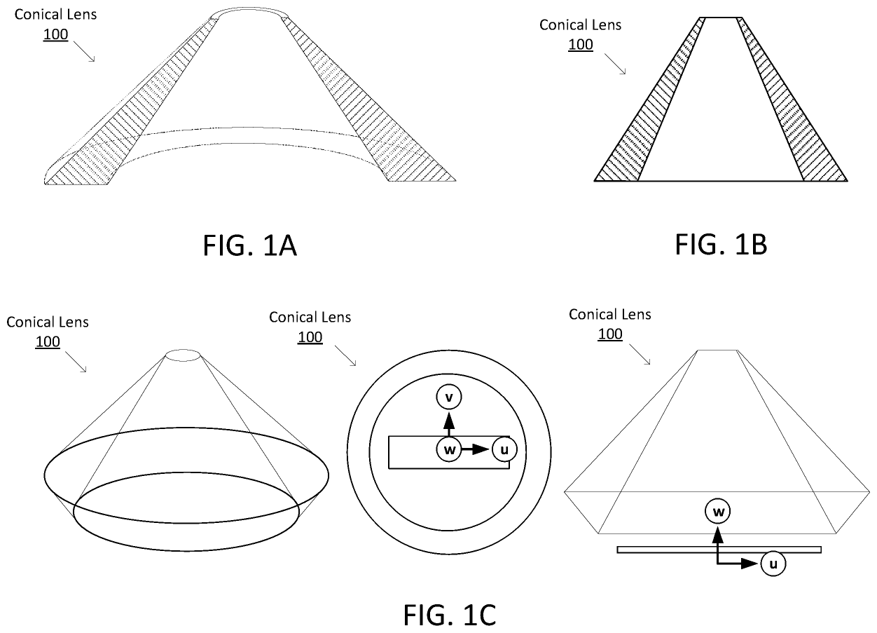

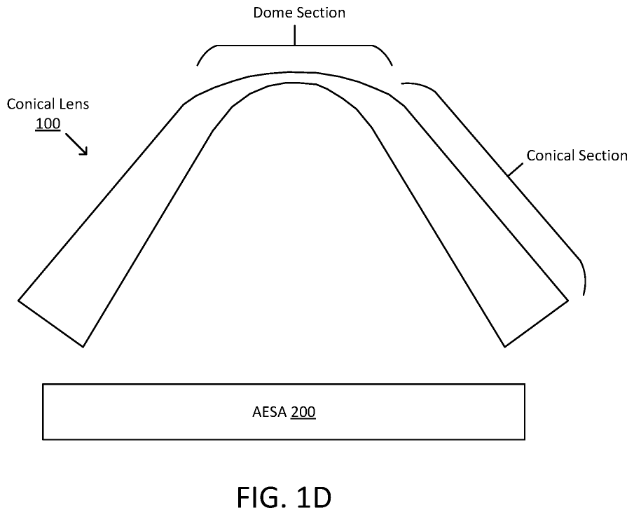

FIG. 1A illustrates a cross-sectional view of a conical lens 100 that may be used with an AESA antenna system in example embodiments. The conical lens 100 may include an inner surface and an outer surface that are each linearly tapered along an elevation direction, such that the conical lens 100 has a thickness that may increase monotonically from a narrower end toward a wider base end. In example embodiments, the geometry of the conical lens 100 may be selected such that electromagnetic energy propagating through the conical lens 100 experiences a progressively increasing electrical path length along the elevation direction, which may produce a substantially uniform or focused wavefront in elevation at an output of the conical lens 100.

In example embodiments, the conical lens 100 may be formed from a dielectric material having a relatively high dielectric constant, such as alumina, zirconia, a high-temperature or thermoplastic polymer material, or Acrylonitrile Butadiene Styrene (ABS), as a nonlimiting example. The use of such materials may allow the conical lens 100 to achieve a desired time delay profile with reduced physical thickness, mass, and overall volume relative to curved or dome-shaped dielectric lenses. The conical lens 100 illustrated in FIG. 1A may further include one or more impedance-matching features at an air-dielectric interface, including matching layers, surface features, or graded dielectric regions, although such features are not explicitly shown in this view.

In a nonlimiting example, the conical lens 100 illustrated in FIG. 1A may be positioned over an AESA antenna aperture such that radio-frequency energy radiated by the AESA antenna propagates through the conical lens 100 prior to transmission into free space. The conical lens 100 may perform a portion of beam steering in elevation by introducing a controlled phase gradient, thereby allowing the AESA antenna to scan over a reduced angular range while achieving a larger effective far-field scan angle. Other example embodiments may use different taper angles, thickness profiles, or material compositions while still providing similar elevation wavefront shaping effects.

FIG. 1B illustrates an alternative cross-sectional view of the conical lens 100, showing a simplified or truncated geometry that may be used in example embodiments. As illustrated, the conical lens 100 may have a generally conical profile with linearly tapered inner and outer surfaces and a reduced height relative to the embodiment shown in FIG. 1A. In example embodiments, truncation of the conical lens 100 may be used to reduce mass, volume, or stowed height while maintaining a desired elevation phase profile across a remaining portion of the lens aperture.

The conical lens 100 of FIG. 1B may be used in systems where packaging constraints, deployment requirements, or mechanical interfaces limit an allowable lens height. The truncated conical lens 100 may still provide scan amplification and elevation wavefront shaping by preserving a portion of the linear thickness gradient along the elevation direction. In some example embodiments, a radome or protective cover may be positioned over an opening of the conical lens 100, and structural supports or stand-off elements may be used to mechanically couple the conical lens 100 to an AESA antenna assembly.

In example embodiments, the conical lens 100 may cooperate with an AESA beamformer that applies azimuth and/or elevation phase or amplitude compensation to address non-uniformities introduced by the lens geometry. Other example embodiments may employ different truncation lengths, symmetry profiles, or mounting configurations while still achieving improved wide-angle scan performance relative to conventional dome-lens-based systems.

FIG. 1C illustrates additional cross-sectional and plan views of truncated conical lenses 100 that may be used with an AESA antenna system in example embodiments. As illustrated, the conical lens 100 may have a generally conical geometry with linearly tapered inner and outer surfaces and a truncated upper portion, resulting in a reduced overall height relative to a full conical profile. In example embodiments, the truncation of the conical lens 100 may preserve a portion of a linear thickness gradient along an elevation direction while removing an upper section of the lens that contributes less to a desired time-delay profile.

In example embodiments, the different views shown in FIG. 1C may illustrate alternative truncation shapes, symmetry profiles, and aperture geometries that may be selected based on system-level constraints. The conical lens 100 may exhibit circular or elliptical symmetry in a plan view, and coordinate directions u, v, and w may be used to define lateral, azimuthal, and elevation-related dimensions or reference directions for design, modeling, or alignment purposes. The conical lens 100 may be configured such that electromagnetic energy propagating through the remaining lens volume experiences a controlled phase delay that supports scan amplification and elevation wavefront shaping, while other example embodiments may employ different truncation ratios or taper angles to achieve similar effects.

In a nonlimiting example, the truncated conical lens 100 illustrated in FIG. 1C may be used in systems where mass reduction, packaging efficiency, or deployment constraints are prioritized, such as space-based RADAR or communication terminals.

In example embodiments, the conical lens 100 may be mounted above an AESA antenna aperture and may cooperate with an AESA beamformer that applies azimuth and/or elevation phase or amplitude compensation to address any non-uniformities introduced by truncation. Other example embodiments not explicitly shown in FIG. 1C may include different truncation heights, asymmetric truncation profiles, or alternative mounting configurations, while still enabling wide-angle scan performance improvements relative to conventional dome-lens-based systems.

The conical lens 100 may include one or more air-dielectric matching layers positioned at an interface between the conical lens 100 and free space. The air-dielectric matching layer may be configured to reduce reflections and impedance mismatch that may otherwise occur when electromagnetic energy transitions between air and a dielectric material of the conical lens 100. In example embodiments, the air-dielectric matching layer may operate as an impedance transformer that gradually transitions an effective permittivity from that of air to that of the dielectric material of the conical lens 100, thereby improving transmission efficiency across a frequency band of interest.

The air-dielectric matching layer may include a quarter-wave matching layer having an effective dielectric constant ε_d selected based on a dielectric constant ε_r of the conical lens 100. In example embodiments, the effective dielectric constant ε_d may be approximately equal to a square root of the dielectric constant ε_r of the conical lens 100, and a thickness t of the matching layer may be selected to be approximately one quarter of a wavelength within the matching-layer material (e.g., t=λ/[4√(√ε_r)]. Such a configuration may allow electromagnetic energy propagating from air into the conical lens 100 to experience reduced reflection at the interface. Other example embodiments may use different thicknesses, effective permittivity values, or multi-layer configurations while still providing impedance matching between air and the dielectric material.

In example embodiments, the air-dielectric matching layer may be implemented as an artificial dielectric structure formed directly in a surface of the conical lens 100. The artificial dielectric structure may include a periodic pattern of surface features, such as holes or grooves, that may modify an effective dielectric constant of the surface region. In example embodiments, the holes or grooves may be arranged in a repeating lattice or unit-cell pattern having a characteristic cell area, and dimensions of the holes or grooves may be selected to achieve a desired effective permittivity. In example embodiments, a minimum number of holes or grooves per wavelength may be used to ensure that the surface behaves as an effective medium rather than a discrete scatterer.

Circular holes may be formed in the surface of the conical lens 100, and a diameter of the holes relative to a unit-cell dimension may be selected to control a fill factor and an effective dielectric constant of the matching layer. In other example embodiments, grooves may be formed in one or more directions, and a groove width, depth, or spacing may be selected to achieve a similar impedance-matching effect. In example embodiments, the choice between holes and grooves may be based on manufacturing considerations, structural requirements, or frequency of operation. Other example embodiments may include combinations of holes and grooves, non-uniform feature sizes, or non-periodic patterns.

In example embodiments, the air-dielectric matching layer may further be configured as a graded-index (GRIN) structure in which an effective dielectric constant varies gradually as a function of depth or position. In such example embodiments, the size, density, or geometry of holes or grooves may vary across the thickness of the matching layer to produce a smooth impedance transition between air and the bulk dielectric material of the conical lens 100. Such a graded transition may further reduce reflections and may improve bandwidth performance. Other example embodiments may use discrete stepped layers, continuous gradients, or hybrid approaches while still achieving impedance matching.

In an example operating scenario, the air-dielectric matching layer described above may be used in a RADAR or communication system operating at millimeter-wave frequencies, such as approximately 30 GHz, as a nonlimiting example. In such example embodiments, the air-dielectric matching layer may reduce insertion loss and improve overall antenna efficiency when electromagnetic energy generated by an AESA 200 propagates through the conical lens 100. Other example embodiments may apply the same matching-layer concepts at different frequencies, with different dielectric materials, or with different surface feature geometries while still remaining within the scope of the present disclosure.

In example embodiments, the conical lens 100 may include a serrated treatment along a rim of the conical lens 100. The serrated treatment may be configured to mitigate beam degradation caused by diffraction effects that may occur at an edge of the conical lens 100 as electromagnetic energy exits the lens into free space. In example embodiments, the serrated treatment may disrupt coherent edge currents or edge-launched diffracted waves, thereby reducing sidelobe levels, smoothing beam transitions, or improving overall beam quality at wide scan angles. As a nonlimiting example, the serrated treatment may include a series of teeth, notches, or non-uniform edge features arranged circumferentially around the rim of the conical lens 100, while other example embodiments may use different serration geometries, spacings, or depths to achieve similar diffraction-mitigation effects.

FIG. 1D illustrates a cross-sectional view of a system including a conical lens 100 positioned over an AESA 200, wherein the conical lens 100 includes a conical section and a dome section. In example embodiments, the conical section of the conical lens 100 may include linearly tapered inner and outer surfaces that define a thickness that increases along an elevation direction relative to the AESA 200. The dome section may extend continuously across an upper opening of the truncated conical section and may relax a discontinuity that may otherwise occur when a portion of electromagnetic energy propagates through the dome section while another portion of the electromagnetic energy escapes through the opening of a truncated conical geometry. In example embodiments, the conical section may introduce an elevation-dependent phase delay as electromagnetic energy propagates through the conical lens 100, and the dome section may cooperate with the conical section to reduce gain loss due to phase disruption and field discontinuities across a transition region of the conical lens 100.

In example embodiments, the dome section of the conical lens 100 may be shaped to reduce gain loss toward boresight and low scan angles by influencing propagation of electromagnetic energy that would otherwise partially bypass the conical section. In example embodiments, the dome section may further act as a radome that may protect the AESA 200 from environmental exposure while allowing electromagnetic energy to propagate therethrough with reduced attenuation or distortion. As a nonlimiting example, in a RADAR or communication system, electromagnetic energy generated by the AESA 200 may propagate upward toward the conical lens 100, pass through the conical section to obtain elevation scan amplification at higher scan angles, and pass through the dome section at lower scan angles to maintain beam continuity and reduce gain degradation before transmission into free space. Other example embodiments may employ different dome shapes, thicknesses, or material properties, or may use alternative structures that relax discontinuities between lens-assisted and non-lens-assisted propagation regions, while still remaining within the scope of the present disclosure.

FIG. 2A illustrates a cross-sectional view of a system that may be used to direct electromagnetic energy using a conical lens 100 positioned over an AESA 200. The AESA 200 may include a plurality of radiating elements arranged to generate a steered beam by applying controlled phase and/or amplitude excitation across the radiating elements. In example embodiments, electromagnetic energy radiated by the AESA 200 may propagate upward toward the conical lens 100, where the electromagnetic energy may enter the conical lens 100 through a lower surface and propagate through a volume of the conical lens 100 having a linearly increasing thickness along an elevation direction.

The conical lens 100 illustrated in FIG. 2A may introduce a controlled phase delay across the propagating electromagnetic energy such that a portion of beam steering in elevation may be performed by the conical lens 100. This may enable scan amplification, where a reduced scan angle generated by the AESA 200 may result in a larger effective far-field scan angle after transmission through the conical lens 100. As a result, the AESA 200 may operate over a reduced scan range while still achieving wide-angle coverage. In a real-world operating scenario, the system illustrated in FIG. 2A may be used in a RADAR or communication terminal where wide elevation scan performance is desired without increasing array size or element density, as a nonlimiting example.

FIG. 2B illustrates a plan view of the system of FIG. 2A, showing an azimuthal relationship between the AESA 200 and the conical lens 100 in example embodiments. As illustrated, the AESA 200 may generate a beam that is steered in an azimuth direction, and the electromagnetic energy may propagate through the conical lens 100 toward free space. In example embodiments, the conical lens 100 may introduce non-uniformities in azimuth due to lens geometry, material properties, or truncation, and the AESA 200 may compensate for such non-uniformities by applying azimuth phase and/or amplitude excitation weights. In a real-world operating scenario, such azimuth compensation may be performed by a beamformer associated with the AESA 200 to maintain beam quality and directivity across a scan volume, while other example embodiments may use different compensation strategies or system configurations to achieve similar results.

FIG. 2C illustrates a near-field (NF) beam cross-section associated with electromagnetic energy that may be generated by an AESA 200 and modified by a conical lens 100 in example embodiments. As illustrated, the beam may exhibit different phase distributions along different directions, including an elevation direction and a lateral direction. In example embodiments, a parabolic phase taper may be applied across one dimension of the beam, such as a lateral or aperture dimension, while a linear phase taper may be applied along an elevation-related dimension. The combination of these phase tapers may influence how the beam propagates through the conical lens 100 and how the beam is redirected toward a desired far-field scan angle.

The linear phase taper illustrated in FIG. 2C may correspond to a thickness gradient of the conical lens 100, which may introduce a controlled, linearly varying electrical path length along the elevation direction. This phase behavior may enable scan amplification by allowing a reduced steering angle generated by the AESA 200 to produce a larger effective far-field scan angle after transmission through the conical lens 100. As a nonlimiting example, in a real-world RADAR or communication system, the AESA 200 may generate a beam with a selected near-field phase distribution, and the conical lens 100 may further shape the beam to achieve wide-angle coverage while maintaining beam quality. Other example embodiments may use different phase taper profiles, beam shapes, or dimensional orientations while still achieving similar beam-shaping and scan-amplification effects.

FIG. 2D illustrates a top view of a system including a conical lens 100 positioned over an AESA 200 in example embodiments. As illustrated, electromagnetic energy generated by the AESA 200 may initially exhibit a substantially uniform phase front prior to interaction with the conical lens 100. In example embodiments, propagation of the electromagnetic energy through the conical lens 100 may introduce phase variations in an azimuth direction due to the geometry, material properties, or truncation of the conical lens 100, resulting in a non-uniform phase front across at least a portion of an aperture.

In example embodiments, the AESA 200 may apply azimuth phase and/or amplitude compensation to account for the non-uniform phase front introduced by the conical lens 100. Such compensation may be performed by a beamformer associated with the AESA 200, which may adjust excitation weights across radiating elements to restore a substantially uniform phase front in azimuth. This compensation may allow the system to maintain beam quality and directivity while benefiting from elevation scan amplification provided by the conical lens 100.

The optimized elevation excitation weights may include phase and/or amplitude excitation values applied to radiating elements of the AESA 200, and may be selected to compensate for phase delays introduced by the conical lens 100 as a function of scan angle. In example embodiments, the optimized elevation excitation weights may allow the system to maintain a desired beam shape and directivity as the beam is scanned over a range of elevation angles.

In example embodiments, the optimized elevation excitation weights may be determined based on analytical models, numerical simulations, calibration measurements, or combinations thereof. The optimized elevation excitation weights may be updated dynamically or may be selected from a predefined set of excitation profiles corresponding to different scan angles, operating frequencies, or lens-assisted propagation conditions. Other example embodiments may apply different optimization criteria or weighting strategies while still preserving beam quality over a continuous scan.

In a nonlimiting example, the configuration illustrated in FIG. 2D may be used in a RADAR or communication system where wide-angle scanning is required across both elevation and azimuth directions. In example embodiments, the conical lens 100 may primarily shape the beam in elevation, while the AESA 200 may perform fine beam control in azimuth through electronic phase and/or amplitude adjustments. Other example embodiments may apply different compensation strategies, lens geometries, or beamforming techniques while still achieving similar phase control and wide-angle scan performance.

FIG. 2E illustrates beam transition regions associated with electromagnetic energy radiated by an AESA 200 and interacting with a conical lens 100. In this example embodiment, the truncated opening is as large as the AESA. As illustrated, the figure shows multiple operating conditions corresponding to different scan angles generated by the AESA 200, including a boresight condition, a wide-angle scan condition, and an intermediate scan condition. In example embodiments, when the AESA 200 operates near boresight, electromagnetic energy may propagate substantially through free space or through a central portion of the conical lens 100, with all radiating elements of the AESA 200 being active.

In example embodiments, when the AESA 200 scans to a larger angle, such as approximately 40 degrees as shown in FIG. 2E, electromagnetic energy may be primarily confined within the conical lens 100. Under such conditions, the AESA 200 may maintain all array elements in an active state, and the conical lens 100 may introduce a controlled phase delay that enables scan amplification and redirection of the beam toward a wider effective far-field scan angle. This operating mode may allow the system to achieve wide-angle coverage while reducing the maximum scan angle required of the AESA 200.

FIG. 2E further illustrates a transition region that may occur at intermediate scan angles, such as approximately 20 degrees. In such operating conditions, a portion of electromagnetic energy may propagate through the conical lens 100, while another portion may propagate outside the lens volume. In example embodiments, the AESA 200 may attenuate or deactivate a subset of radiating elements to manage beam quality, sidelobe levels, or transition behavior between lens-assisted and non-lens-assisted propagation regions. As a nonlimiting example, such beam transition management may be used in a RADAR or communication system to provide smooth scanning performance across a continuous scan volume. Other example embodiments may use different attenuation strategies, scan thresholds, or element control schemes while still achieving controlled beam transitions and wide-angle scan performance.

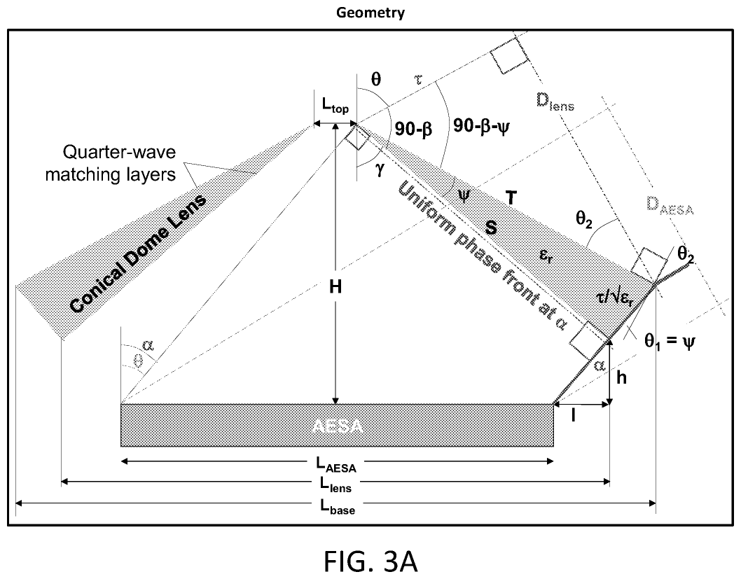

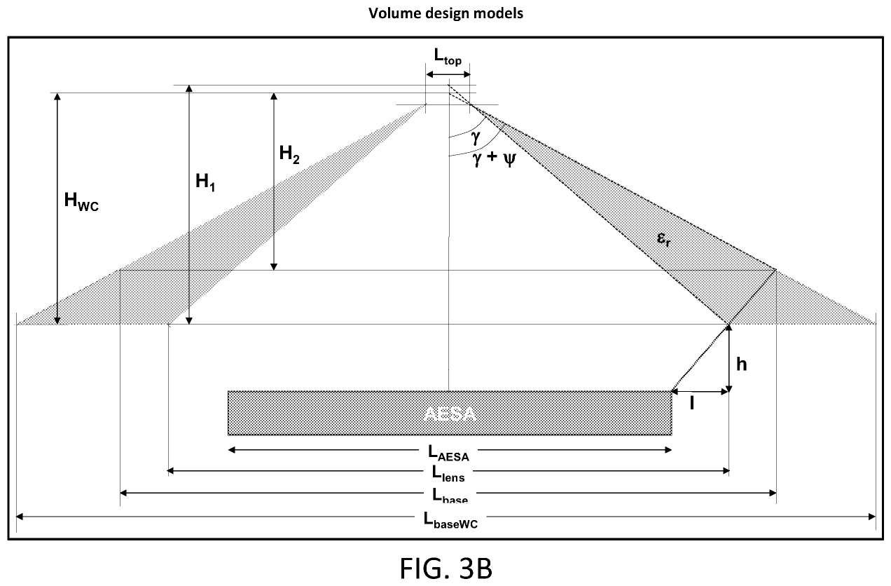

FIG. 3A illustrates a geometric model associated with a conical lens 100 positioned over an AESA 200. As illustrated, the geometric relationships may define how electromagnetic energy propagating from the AESA 200 may traverse the conical lens 100 and emerge with a desired phase distribution. In example embodiments, the AESA 200 may radiate electromagnetic energy at a scan angle α, and the electromagnetic energy may enter the conical lens 100 at an interface that may include one or more quarter-wave impedance matching layers. The quarter-wave matching layers may be configured to reduce reflections at an air-dielectric interface while allowing energy to efficiently couple into the conical lens 100.

In example embodiments, the conical lens 100 may have a linearly tapered geometry defined by parameters including a lens height H, a top thickness L_top, and a base width L_base, with the taper producing a linearly increasing thickness along an elevation direction. As illustrated, the propagation path S through the conical lens 100 may vary as a function of position, such that electromagnetic energy experiences a progressively increasing electrical path length as a function of elevation. In example embodiments, angles such as β, ψ, θ, and τ may represent refraction and propagation angles associated with entry into, traversal through, and exit from the conical lens 100, as determined by Snell's law and the dielectric constant of the lens material. The conical geometry may be selected such that electromagnetic energy exiting the conical lens 100 may form a substantially uniform phase front at an output plane.

In example embodiments, FIG. 3A further illustrates how the conical lens 100 may be configured to generate a uniform phase front at an angle α relative to the AESA 200, despite the AESA 200 operating at a reduced scan angle θ₁. This relationship may enable scan amplification, where a smaller AESA scan angle may produce a larger effective far-field scan angle after transmission through the conical lens 100. In example embodiments, distances such as D_AESA and D_lens may represent characteristic aperture dimensions that influence beam shape, phase curvature, and coupling efficiency between the AESA 200 and the conical lens 100.

In a nonlimiting example, the geometric relationships illustrated in FIG. 3A may be used as a starting point for analytical modeling or numerical simulation when designing a lens-AESA system for RADAR or communication applications. In example embodiments, the parameters illustrated in FIG. 3A may be adjusted to account for different dielectric materials, operating frequencies, scan ranges, or packaging constraints. Other example embodiments may use alternative geometric formulations, approximations, or optimization techniques while still employing a conical lens 100 that introduces a controlled elevation-dependent phase delay to achieve scan amplification and improved wide-angle performance.

FIG. 3B illustrates a volume-based design model associated with a conical lens 100 positioned over an AESA 200. As illustrated, the conical lens 100 may be defined by a set of geometric parameters that relate lens height, lens volume, and packaging constraints to the placement of the AESA 200. In example embodiments, the conical lens 100 may include a top thickness L_top, a base width L_base, and a total lens height H, where the lens height H may be measured relative to a reference plane associated with the AESA 200.

In example embodiments, FIG. 3B may further illustrate multiple height parameters, such as H₁, H₂, and H_wc, that may correspond to different lens truncation options, stowage envelopes, or worst-case packaging constraints. The conical lens 100 may be truncated at different heights to reduce mass, volume, or overall system height while preserving a desired thickness gradient along an elevation direction. The truncated geometry may maintain a portion of the linear taper sufficient to produce a controlled elevation-dependent phase delay, while removing lens material that contributes less to scan amplification or wavefront shaping.

The AESA 200 illustrated in FIG. 3B may be positioned at a distance h below a lower surface of the conical lens 100, where the distance h may be selected to control coupling between the AESA 200 and the conical lens 100. The AESA 200 may have an aperture length L_AESA, and the conical lens 100 may have a corresponding effective aperture length L_lens, where relative sizing of these dimensions may influence beam coupling efficiency, spillover loss, and edge diffraction behavior. In example embodiments, the conical lens 100 may extend laterally beyond the AESA 200 to provide additional control over beam shaping at wide scan angles.

In example embodiments, FIG. 3B may further illustrate angular relationships, such as γ and ψ, that may describe internal propagation or refraction behavior within the conical lens 100, as well as an effective dielectric constant ε_r associated with the lens material. These parameters may be used in analytical models or simulation tools to estimate lens volume, mass, and performance tradeoffs. In a nonlimiting example, the volume design relationships illustrated in FIG. 3B may be used when designing a RADAR or communication terminal that must fit within a constrained enclosure, such as a satellite payload fairing or a vehicle-mounted radome.

The geometric and volume parameters illustrated in FIG. 3B may be adjusted to account for different operating frequencies, dielectric materials, scan requirements, or deployment mechanisms. Other example embodiments may employ different truncation heights, spacing distances, or dimensional ratios while still enabling scan amplification and wide-angle beam performance using a conical lens 100 in cooperation with an AESA 200.

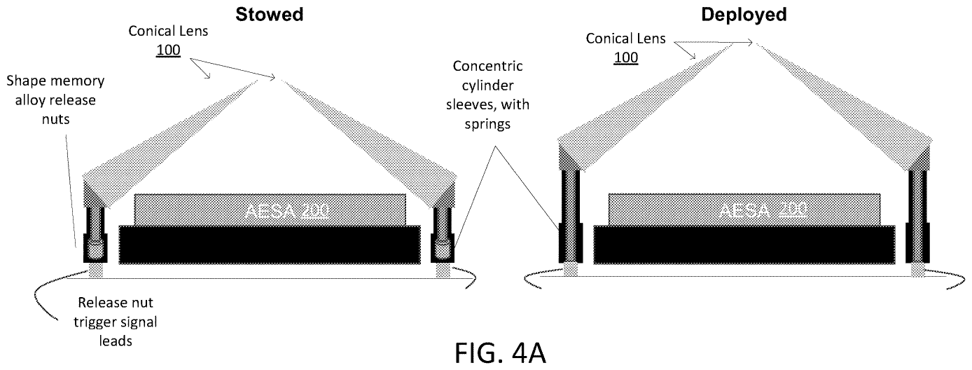

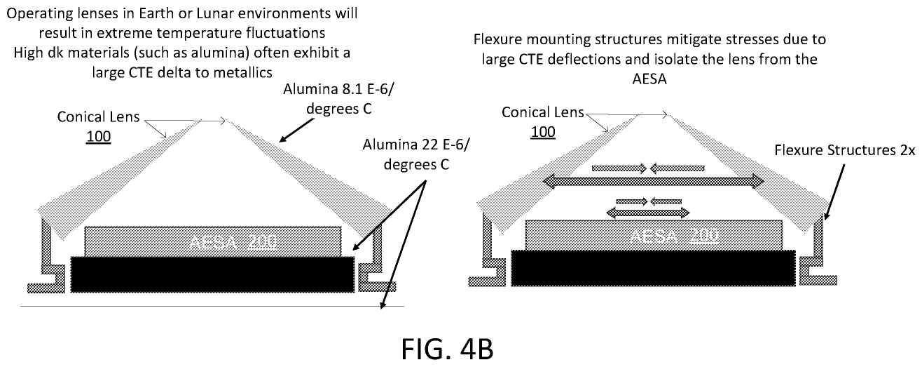

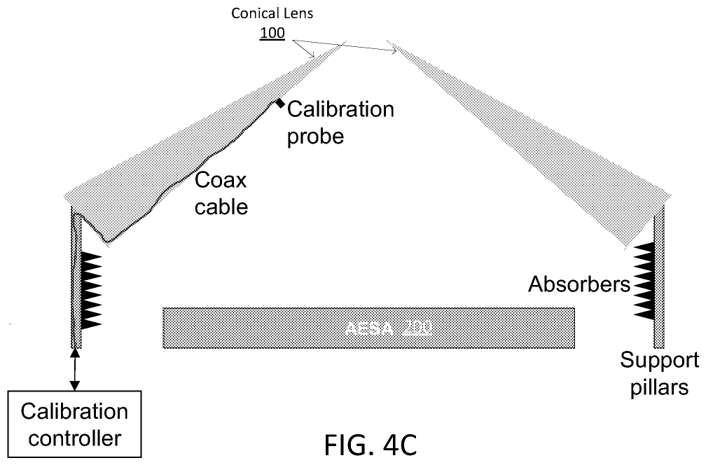

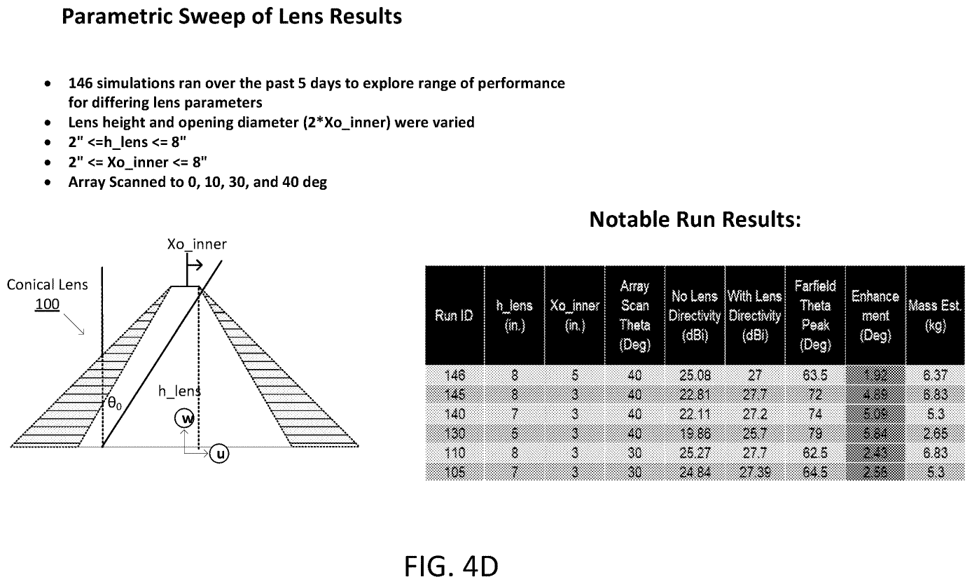

FIG. 4A illustrates a deployment system for a conical lens 100 used with an AESA 200, showing both a stowed configuration and a deployed configuration in example embodiments. In the stowed configuration, the conical lens 100 may be positioned in a folded or lowered state relative to the AESA 200 to reduce an overall system height. In example embodiments, the conical lens 100 may be mechanically coupled to a set of concentric cylinder sleeves with springs, which may constrain the conical lens 100 in the stowed configuration prior to deployment.

In example embodiments, the deployment system illustrated in FIG. 4A may include one or more shape memory alloy release nuts that may retain the concentric cylinder sleeves in the stowed configuration. The shape memory alloy release nuts may be electrically coupled to release-nut trigger signal leads, which may deliver an activation signal to initiate deployment. Upon receipt of the activation signal, the shape memory alloy release nuts may transition to a released state, thereby allowing the concentric cylinder sleeves and associated springs to extend and move the conical lens 100 away from the AESA 200 into the deployed configuration.

In the deployed configuration illustrated in FIG. 4A, the conical lens 100 may be positioned at a predetermined distance above the AESA 200 to establish a desired electromagnetic coupling and phase-delay relationship between the AESA 200 and the conical lens 100. In example embodiments, the deployment distance may be selected based on lens geometry, operating frequency, or beam-shaping requirements. The concentric cylinder sleeves may provide structural support for the conical lens 100 while maintaining alignment between the conical lens 100 and the AESA 200 during operation.

In a nonlimiting example, the deployment system illustrated in FIG. 4A may be used in a space-based RADAR or communication system where the antenna system is stowed during launch and deployed after reaching orbit. In example embodiments, the use of shape memory alloy release nuts may provide a resettable and electrically actuated deployment mechanism, while the spring-biased concentric cylinder sleeves may enable controlled, repeatable deployment of the conical lens 100. Other example embodiments may employ different numbers of release nuts, alternative actuator technologies, or different support geometries while still enabling transition between stowed and deployed configurations for reduced packaging height and operational lens placement.

FIG. 4B illustrates a mounting configuration for a conical lens 100 positioned relative to an AESA 200, showing how thermal expansion effects may be managed in example embodiments. As illustrated, the conical lens 100 may be formed from a high-dielectric-constant material, such as alumina, which may exhibit a coefficient of thermal expansion (CTE) that differs from that of metallic structures associated with the AESA 200. In example embodiments, operation of the conical lens 100 and the AESA 200 in environments such as Earth-based or lunar environments may result in extreme temperature fluctuations that cause differential expansion or contraction between the conical lens 100 and supporting structures.

In example embodiments, FIG. 4B illustrates one or more flexure mounting structures that may be positioned between the conical lens 100 and the AESA 200 to mitigate stresses resulting from CTE mismatch. The flexure mounting structures may allow controlled relative motion between the conical lens 100 and the AESA 200 while maintaining positional alignment required for electromagnetic performance. In example embodiments, the flexure mounting structures may isolate the conical lens 100 from mechanical loads transmitted by the AESA 200, thereby reducing stress concentrations and minimizing the risk of cracking, deformation, or misalignment of the conical lens 100.

The flexure mounting structures illustrated in FIG. 4B may be used in combination with deployment mechanisms, such as release nuts and support sleeves, as described with respect to FIG. 4A. The flexure mounting structures may cooperate with such mechanisms to accommodate thermal expansion both during deployment and during steady-state operation. As a nonlimiting example, in a space-based RADAR or communication system, the flexure mounting structures may allow the conical lens 100 to remain mechanically isolated from the AESA 200 while the system experiences repeated thermal cycling due to orbital day-night transitions.

In example embodiments, the number, geometry, and placement of the flexure mounting structures may be selected based on expected temperature ranges, material properties, lens mass, or structural constraints. Other example embodiments may use different compliant structures, alternative flexure geometries, or hybrid mounting approaches while still accommodating CTE mismatch and maintaining desired electromagnetic alignment between the conical lens 100 and the AESA 200.

FIG. 4C illustrates additional system features that may be incorporated into a conical lens 100 and AESA 200 assembly in example embodiments. As illustrated, the conical lens 100 may be positioned above the AESA 200 and may be supported by one or more support pillars that mechanically couple the conical lens 100 to a supporting structure. In example embodiments, the support pillars may provide structural stability while maintaining a desired separation distance between the conical lens 100 and the AESA 200, thereby preserving electromagnetic coupling characteristics established during system design.

In example embodiments, FIG. 4C further illustrates one or more absorbers positioned along a base region or inner surface of the conical lens 100 or adjacent to the support pillars. The absorbers may be configured to attenuate stray electromagnetic energy, reduce reflections, or mitigate edge diffraction effects that may otherwise degrade beam quality or increase sidelobe levels. In example embodiments, the absorbers may be formed from lossy dielectric or resistive materials selected based on operating frequency and environmental constraints. As a nonlimiting example, such absorbers may be used in RADAR or communication systems to improve beam stability across a continuous scan volume.

FIG. 4C further illustrates a calibration subsystem that may be used to characterize or adjust system performance in example embodiments. As illustrated, a calibration probe may be positioned within or adjacent to the conical lens 100, and the calibration probe may be coupled to a calibration controller via a coaxial cable. In example embodiments, the calibration probe may receive or transmit calibration signals that may be used to measure phase, amplitude, or timing characteristics of electromagnetic energy propagating through the conical lens 100 and generated by the AESA 200. The calibration controller may process such measurements to generate calibration data that may be used to adjust AESA excitation weights or compensation parameters.

The stand-off pillars may replace a portion of a continuous base structure while maintaining mechanical support and positional alignment between the conical lens 100 and the AESA 200. In example embodiments, the use of stand-off pillars may reduce an overall mass of the conical lens 100 and associated support structures by removing material from regions that contribute less to electromagnetic performance.

The stand-off pillars may be arranged circumferentially around a perimeter of the conical lens 100, or may be positioned at discrete locations selected to balance structural stiffness and mass reduction. The stand-off pillars may be formed from metallic, composite, or dielectric materials and may be integrally formed with, or mechanically coupled to, the conical lens 100. Other example embodiments may use different numbers, geometries, or placements of stand-off pillars while still achieving weight reduction and maintaining mechanical stability.

As a nonlimiting example, the stand-off pillar configuration may be used in a space-based RADAR or communication system where mass reduction is prioritized to meet launch vehicle constraints. Other example embodiments may employ alternative base-modification structures or partial base removal techniques while still providing weight reduction and structural support for the conical lens 100.

In an example operating scenario, the configuration illustrated in FIG. 4C may be used during system initialization, maintenance, or periodic recalibration in environments where temperature changes, mechanical tolerances, or aging effects may alter system performance, as a nonlimiting example. In example embodiments, the calibration probe, absorbers, and support pillars may be used individually or in combination, and other example embodiments may include additional sensors, alternative absorber placements, or different calibration architectures while still supporting accurate beam control and stable operation of the lens-AESA system.

FIG. 4D illustrates results of a parametric sweep that may be used to evaluate performance characteristics of a conical lens 100 used with an AESA 200 in example embodiments. As illustrated, a plurality of simulations may be performed to explore how variations in lens geometry affect beam performance, scan amplification, and mass. In example embodiments, the parametric sweep may include varying a lens height h_lens and an inner opening diameter Xo_inner of the conical lens 100, while operating the AESA 200 at different scan angles. The illustrated results may provide insight into tradeoffs between electromagnetic performance and physical characteristics such as lens size and weight.

FIG. 4D shows that the AESA 200 may be scanned to multiple angles, such as 0 degrees, 10 degrees, 30 degrees, and 40 degrees, while the conical lens 100 modifies the resulting beam. For each simulation run, performance metrics may include directivity without the conical lens 100, directivity with the conical lens 100, a resulting far-field beam peak angle, and an enhancement value representing a change in directivity. In example embodiments, the far-field beam peak angle may exceed the scan angle of the AESA 200, thereby demonstrating scan amplification provided by the conical lens 100.

FIG. 4D further illustrates that different combinations of lens height h_lens and inner opening diameter Xo_inner may produce different levels of scan amplification and directivity enhancement. Some parameter combinations may yield higher enhancement values at wide scan angles, while other combinations may reduce lens mass or overall volume. In example embodiments, an estimated mass of the conical lens 100 may be calculated based on lens geometry and material properties to allow comparison of electromagnetic performance against physical constraints.

In an example operating scenario, the parametric sweep illustrated in FIG. 4D may be used during a design phase to select lens dimensions that balance wide-angle scan performance, mass, and packaging requirements for a RADAR or communication system, as a nonlimiting example. In example embodiments, the illustrated simulation results may serve as guidance rather than fixed limitations, and other example embodiments may include different parameter ranges, additional variables, or alternative performance metrics while still using similar parametric analysis techniques to design a conical lens 100 for use with an AESA 200.

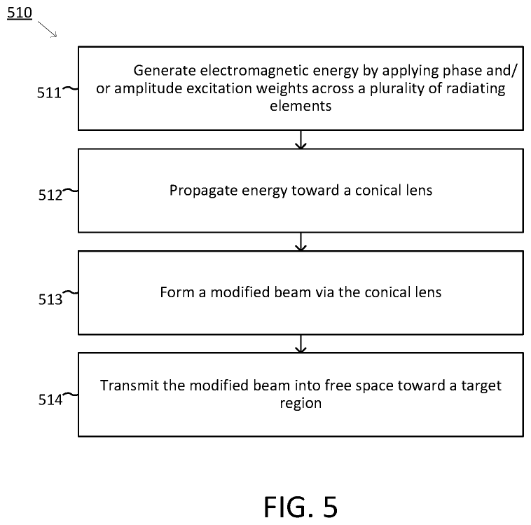

FIG. 5 illustrates a process 510 for directing electromagnetic energy using a conical lens 100 and an AESA that may be performed by a system in example embodiments. The actions illustrated in FIG. 5 may, in other example embodiments, be performed in a different order, omitted, or repeated. The process may be used to generate a steered beam with reduced scan loss and improved wide-angle performance by distributing beam-forming functions between the AESA and the conical lens.

The AESA may generate 511 electromagnetic energy by applying phase and/or amplitude excitation weights across a plurality of radiating elements. In example embodiments, the AESA may electronically control the excitation applied to the radiating elements to steer the electromagnetic energy toward a selected elevation and azimuth direction. As a nonlimiting example, this action may be performed in a RADAR or communication system to scan a coverage region without mechanically moving the antenna system.

The electromagnetic energy generated by the AESA may propagate 512 toward the conical lens. In example embodiments, the electromagnetic energy may enter the conical lens through an input surface and propagate through a volume of the conical lens having a linearly increasing thickness along an elevation direction. The conical lens may introduce a controlled phase delay as the electromagnetic energy propagates through the lens material.

The system may form 513 a modified beam via the conical lens. In example embodiments, the conical lens may shape the electromagnetic energy to produce a substantially uniform or focused wavefront in elevation and may enable scan amplification such that a reduced scan angle generated by the AESA results in a larger effective far-field scan angle. In some example embodiments, non-uniformities introduced by the conical lens, such as azimuth-dependent phase variations, may be compensated by applying additional phase and/or amplitude excitation weights at the AESA.

The system may transmit 514 the modified beam into free space toward a target region. In example embodiments, the process illustrated in FIG. 5 may be repeated for different scan angles or operating conditions to provide continuous wide-angle coverage. Other example embodiments may include additional actions, such as calibration, element attenuation, or compensation updates, while still using the conical lens and the AESA to direct electromagnetic energy toward a desired region.

Various embodiments may be described in the following clauses:
1. A system, comprising:
   an active electronically steered array (AESA) to transmit or receive signals; and
   a conical lens comprising a thickness that increases along an elevation direction of the conical lens, and a dielectric material having a dielectric constant of at least approximately two,
   wherein the conical lens is to introduce, based on at least an elevation of the conical lens, an increasing phase delay from top to bottom to provide amplification of the signals.
2. The system of clause 1, wherein the conical lens is a truncated conical lens having an opening opposite the AESA, and wherein the phase delay is further to provide amplification of the signals toward elevation angles of approximately 60 degrees and higher.
3. The system of clause 2, further comprising a dome extending the conical lens and covering a top opening of the conical lens.
4. The system of clause 1, wherein the conical lens has circular symmetry or elliptical symmetry about a central axis.
5. The system of clause 1, wherein the dielectric material comprises alumina, zirconia, a thermoplastic polymer material like Acrylonitrile Butadiene Styrene (ABS), or any dielectric material.
6. The system of clause 1, further comprising at least one air-dielectric matching layer positioned at an interface between the conical lens and free space.
7. The system of clause 6, wherein the at least one air-dielectric matching layer comprises a quarter-wave matching layer, a homogeneous dielectric matching layer, an artificial dielectric matching layer comprising surface holes or grooves, a graded-index matching layer, or a combination thereof.
8. The system of clause 1, wherein the AESA is to apply at least one of azimuth phase compensation, elevation phase compensation, amplitude compensation, or a combination thereof to compensate for non-uniformities introduced by the conical lens.
9. The system of clause 1, wherein the AESA is to apply optimized elevation excitation weights to preserve beam quality and gain over a continuous scan volume.
10. A system, comprising:
   an active electronically steered array (AESA); and
   a conical dielectric lens positioned over the AESA,
   wherein the conical dielectric lens has a linearly increasing thickness along an elevation direction and is to modify signals generated by the AESA.
11. The system of clause 10, further comprising:
   a calibration probe positioned within or adjacent to the conical dielectric lens,
   a calibration controller coupled to the calibration probe via a coaxial cable, and
   one or more absorbers positioned along a base region of the conical dielectric lens,
   wherein the calibration probe is to receive or transmit calibration signals associated with signals generated by the active electronically steered array.
12. The system of clause 10, wherein the conical dielectric lens is to reduce scan loss at wide scan angles.
13. The system of clause 10, further comprising one or more absorbers positioned along a base region of the conical dielectric lens.
14. The system of clause 10, wherein the conical dielectric lens is truncated on a bottom base and supported by a plurality of stand-off pillars to reduce mass while maintaining mechanical alignment.
15. The system of clause 10, further comprising a deployment mechanism to move the conical dielectric lens between a stowed configuration and a deployed configuration.
16. A conical dielectric lens comprising a thickness that increases along an elevation direction and is to modify a beam generated by an active electronically steered array (AESA).
17. The conical dielectric lens of clause 16, further comprising a serrated treatment along a rim of the conical dielectric lens to mitigate beam degradation due to diffraction effects.
18. The conical dielectric lens of clause 16, further to be deployed for reduced height inside a launch vehicle.
19. The conical dielectric lens of clause 16, wherein the conical dielectric lens is formed from a dielectric material having a dielectric constant of approximately ten.
20. The conical dielectric lens of clause 16, wherein the conical dielectric lens is to be used in a RADAR system or a communication system.

Other variations are within the spirit of the present disclosure. Thus, while disclosed techniques are susceptible to various modifications and alternative constructions, certain illustrated embodiments thereof are shown in drawings and have been described above in detail. It should be understood, however, that there is no intention to limit disclosure to a specific form or forms disclosed, but on the contrary, the intention is to cover all modifications, alternative constructions, and equivalents falling within the spirit and scope of disclosure, as defined in the appended claims.

Use of terms “a” and “an” and “the” and similar referents in the context of describing disclosed embodiments (especially in the context of the following claims) is to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein is merely intended to serve as a shorthand method of referring individually to each separate value falling within range, unless otherwise indicated herein, and each separate value is incorporated into the specification as if it were individually recited herein. In at least one embodiment, use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B, and at least one of C to be present. In addition, unless otherwise noted or contradicted by context, the term “plurality” indicates a state of being plural (e.g., “a plurality of items” indicates multiple items). In at least one embodiment, the number of items in a plurality is at least two, but can be more when so indicated either explicitly or by context. Further, unless stated otherwise or otherwise clear from context, the phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, a set of non-transitory computer-readable storage media comprises multiple non-transitory computer-readable storage media, and one or more of the individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium stores instructions and a main central processing unit (“CPU”) executes some of the instructions while a graphics processing unit (“GPU”) executes other instructions. In at least one embodiment, different components of a computer system have separate processors, and different processors execute different subsets of instructions.

In at least one embodiment, an arithmetic logic unit is a set of combinational logic circuitry that takes one or more inputs to produce a result. In at least one embodiment, an arithmetic logic unit is used by a processor to implement mathematical operations such as addition, subtraction, or multiplication. In at least one embodiment, an arithmetic logic unit is used to implement logical operations such as logical AND/OR or XOR. In at least one embodiment, an arithmetic logic unit is stateless and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to the inputs of the arithmetic logic unit. In at least one embodiment, the instruction codes provided by the processor to the ALU are based at least in part on the instruction executed by the processor. In at least one embodiment, combinational logic in the ALU processes the inputs and produces an output that is placed on a bus within the processor. In at least one embodiment, the processor selects a destination register, memory location, output device, or output storage location on the output bus so that clocking the processor causes the results produced by the ALU to be sent to the desired location.

In the scope of this application, the term arithmetic logic unit, or ALU, is used to refer to any computational logic circuit that processes operands to produce a result. For example, in the present document, the term ALU can refer to a floating point unit, a DSP, a tensor core, a shader core, a coprocessor, or a CPU.

Accordingly, in at least one embodiment, computer systems are configured to implement one or more services that singly or collectively perform operations of processes described herein, and such computer systems are configured with applicable hardware and/or software that enable performance of operations. Further, a computer system that implements at least one embodiment of the present disclosure is a single device and, in another embodiment, is a distributed computer system comprising multiple devices that operate differently, such that the distributed computer system performs operations described herein and such that a single device does not perform all operations.

Use of any and all examples, or exemplary language (e.g., “such as”) provided herein, is intended merely to better illuminate embodiments of disclosure and does not pose a limitation on the scope of disclosure unless otherwise claimed. No language in the specification should be construed as indicating any non-claimed element as essential to the practice of disclosure.

In description and claims, terms “coupled” and “connected,” along with their derivatives, may be used. It should be understood that these terms may not be intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but still cooperate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transforms that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, the terms “system” and “method” are used herein interchangeably insofar as a system may embody one or more methods and methods may be considered a system.

In the present document, references may be made to obtaining, acquiring, receiving, or inputting analog or digital data into a subsystem, computer system, or computer-implemented machine. In at least one embodiment, the process of obtaining, acquiring, receiving, or inputting analog and digital data can be accomplished in a variety of ways, such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from a providing entity to an acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface, or an interprocess communication mechanism.

Although descriptions herein set forth example implementations of described techniques, other architectures may be used to implement described functionality, and are intended to be within the scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A system, comprising:
an active electronically steered array (AESA) to transmit or receive signals; and
a conical lens comprising a thickness that increases along an elevation direction of the conical lens, and a dielectric material having a dielectric constant of at least approximately two,
wherein the conical lens is to introduce, based on at least an elevation of the conical lens, an increasing phase delay from top to bottom to provide amplification of the signals.

2. The system of claim 1, wherein the conical lens is a truncated conical lens having an opening opposite the AESA, and wherein the phase delay is further to provide amplification of the signals toward elevation angles of approximately 60 degrees and higher.

3. The system of claim 2, further comprising a dome extending the conical lens and covering a top opening of the conical lens.

4. The system of claim 1, wherein the conical lens has circular symmetry or elliptical symmetry about a central axis.

5. The system of claim 1, wherein the dielectric material comprises alumina, zirconia, a thermoplastic polymer material like Acrylonitrile Butadiene Styrene (ABS), or any dielectric material.

6. The system of claim 1, further comprising at least one air-dielectric matching layer positioned at an interface between the conical lens and free space.

7. The system of claim 6, wherein the at least one air-dielectric matching layer comprises a quarter-wave matching layer, a homogeneous dielectric matching layer, an artificial dielectric matching layer comprising surface holes or grooves, a graded-index matching layer, or a combination thereof.

8. The system of claim 1, wherein the AESA is to apply at least one of azimuth phase compensation, elevation phase compensation, amplitude compensation, or a combination thereof to compensate for non-uniformities introduced by the conical lens.

9. The system of claim 1, wherein the AESA is to apply optimized elevation excitation weights to preserve beam quality and gain over a continuous scan volume.

10. A system, comprising:
an active electronically steered array (AESA); and
a conical dielectric lens positioned over the AESA,
wherein the conical dielectric lens has a linearly increasing thickness along an elevation direction and is to modify signals generated by the AESA.

11. The system of claim 10, further comprising:
a calibration probe positioned within or adjacent to the conical dielectric lens,
a calibration controller coupled to the calibration probe via a coaxial cable, and
one or more absorbers positioned along a base region of the conical dielectric lens,
wherein the calibration probe is to receive or transmit calibration signals associated with signals generated by the active electronically steered array.

12. The system of claim 10, wherein the conical dielectric lens is to reduce scan loss at wide scan angles.

13. The system of claim 10, further comprising one or more absorbers positioned along a base region of the conical dielectric lens.

14. The system of claim 10, wherein the conical dielectric lens is truncated on a bottom base and supported by a plurality of stand-off pillars to reduce mass while maintaining mechanical alignment.

15. The system of claim 10, further comprising a deployment mechanism to move the conical dielectric lens between a stowed configuration and a deployed configuration.

16. A conical dielectric lens comprising a thickness that increases along an elevation direction and is to modify a beam generated by an active electronically steered array (AESA).

17. The conical dielectric lens of claim 16, further comprising a serrated treatment along a rim of the conical dielectric lens to mitigate beam degradation due to diffraction effects.

18. The conical dielectric lens of claim 16, further to be deployed for reduced height inside a launch vehicle.

19. The conical dielectric lens of claim 16, wherein the conical dielectric lens is formed from a dielectric material having a dielectric constant of approximately ten.

20. The conical dielectric lens of claim 16, wherein the conical dielectric lens is to be used in a RADAR system or a communication system.
